(19) United States
(12) Patent Application Publication
(10) Pub. No.: US 2018/0141530 A1
(43) Pub. Date: May 24, 2018

(54) BRAKE-BY-WIRE SYSTEM

(71) Applicant: GM Global Technology Operations LLC, Detroit, MI (US)

(72) Inventors: Paul A. Kilmurray, Wixom, MI (US); Kevin S. Kidston, New Hudson, MI (US); Alan J. Houtman, Milford, MI (US)

(21) Appl. No.: 15/359,075

(22) Filed: Nov. 22, 2016

(51) Int. Cl. B60T 13/74; B60T 7/04

(52) U.S. Cl. CPC B60T 13/745; B60T 2270/402; B60T 2270/82; B60T 7/042

(57) ABSTRACT

A brake-by-wire system includes a controller, a brake assembly, a pedal assembly, and a hydraulic backup assembly. The brake assembly includes a brake and an actuator connected to the brake when the system is in a normal mode. The pedal assembly is coupled to the brake when the system is in a backup mode, and is coupled to the controller when in the normal mode. The controller receives braking signals from the pedal assembly and outputs a command signal to the actuator. The actuator drives the brake in the normal mode. The backup assembly includes a hydraulic line in controlled fluid communication with the brake and pedal assembly. A valve is in a normal position that isolates the pedal assembly from the brake when in the normal mode, and is in a backup position that provides communication between the pedal assembly and the brake when in the backup mode.

### INTRODUCTION

The subject invention relates to a brake-by-wire (BBW) system, and more particularly, to a hydraulic backup assembly of the BBW system.

Traditional service braking systems of a vehicle are typically hydraulic fluid based systems actuated by a driver depressing a brake pedal that generally actuates a master cylinder. In-turn, the master cylinder pressurizes hydraulic fluid in a series of hydraulic fluid lines routed to respective actuators at brakes located adjacent to each wheel of the vehicle. Such hydraulic braking may be supplemented by a hydraulic modulator assembly that facilitates anti-lock braking, traction control, and vehicle stability augmentation features. The wheel brakes may be primarily operated by the manually actuated master cylinder with supplemental actuation pressure gradients supplied by the hydraulic modulator assembly during anti-lock, traction control, and stability enhancement modes of operation.

When a plunger of the master cylinder is depressed by the brake pedal to actuate the wheel brakes, pedal resistance is encountered by the driver. This resistance may be due to a combination of actual braking forces at the wheels, hydraulic fluid pressure, mechanical resistance within the booster/master cylinder, the force of a return spring acting on the brake pedal, and other factors. Consequently, a driver is accustomed to and expects to feel this resistance as a normal occurrence during operation of the vehicle.

More recent advancements in braking systems include BBW systems that actuate the vehicle brakes via an electric signal typically generated by an on-board controller. Brake torque may be applied to the wheel brakes without a direct hydraulic link to the brake pedal. The BBW system may be an add-on, (i.e., and/or replace a portion of the more conventional hydraulic brake systems), or may completely replace the hydraulic brake system (i.e., a pure BBW system). In either type of BBW system, the brake pedal ‘feel’, which a driver is accustomed to, may be emulated.

Present implementations of BBW systems may not include system redundancies to enhance tolerance of unexpected operating conditions or undesired events. Accordingly, enhancements to system tolerance and/or robustness is desirable.

### SUMMARY

In one exemplary embodiment of the invention, a brake-by-wire (BBW) system of a vehicle includes a controller, a brake assembly, a brake pedal assembly, and a hydraulic backup assembly. The brake assembly includes a brake and an actuator operatively connected to the brake when the BBW system is in at least a normal operating mode. The brake pedal assembly is operatively coupled to the brake when the BBW system is in a backup operating mode, and is operatively coupled to the controller when in the normal operating mode. The controller is configured to receive braking intent signals from the brake pedal assembly and output a command signal to the actuator. The actuator is constructed and arranged to drive the brake, indicative of the command signal, when the BBW system is in the normal operating mode. The hydraulic backup assembly includes a hydraulic line in controlled fluid communication with and between the brake and the brake pedal assembly, and a valve coupled to the hydraulic line and constructed and arranged to be in a normal position, hydraulically isolating the brake pedal assembly from the brake, indicative of the normal operating mode, and in a backup position, providing fluid communication between the brake pedal assembly and the brake indicative of the backup operating mode.

In another exemplary embodiment of the invention, a method of operating a BBW system includes operating a brake pedal assembly with a diverter valve in a normal position during a normal operating mode of the system. During normal operation, fluid communication is provided between a hydraulic cylinder and a hydraulic emulator of the brake pedal assembly. When the diverter valve is de-energized, the diverter valve moves from the normal position to a backup position, thus providing fluid communication between the hydraulic cylinder and a brake.

The above features and advantages and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic of a vehicle having a BBW system as one, non-limiting, example in accordance with the present disclosure;

FIG. 2 is a schematic of the BBW system including a hydraulic backup system; and

FIG. 3 is a flow chart of a method of operating the BBW system.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the terms module and controller refer to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

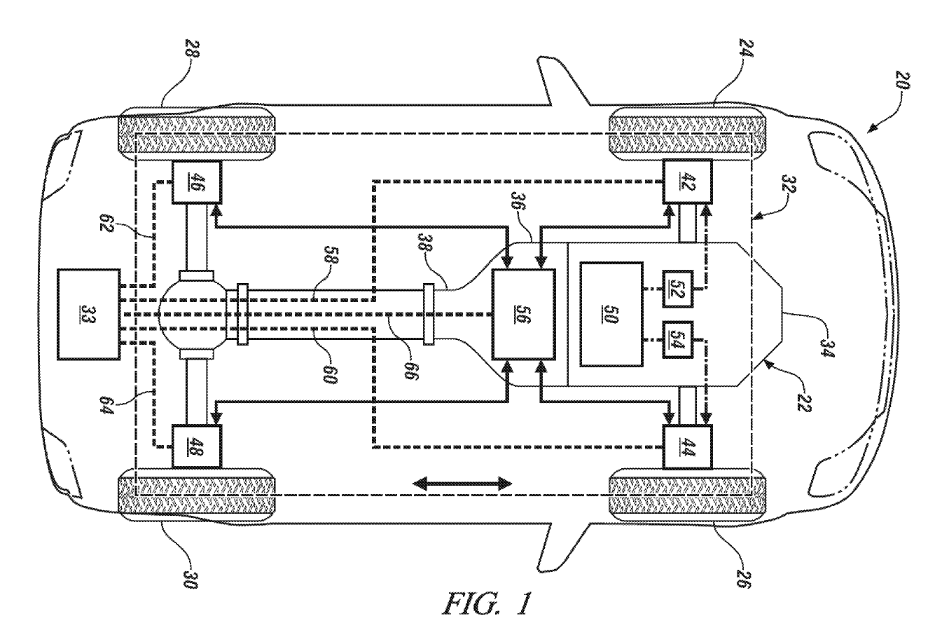

In accordance with one, non-limiting, embodiment of the present disclosure, FIG. 1 is a schematic of a vehicle 20 that may include a powertrain 22, a plurality of rotating wheels (i.e., two front wheels 24, 26 and two rear wheels 28, 30 illustrated), a BBW system 32, and an electric power source 33. The powertrain 22 may include an engine 34, a transmission 36, and a transfer case 38. The engine 34 generates a drive torque that may be transferred to the transmission 36 via a rotating crank shaft (not shown). The transmission 36 generally adjusts the drive torque that is delivered to one or all of the wheels 24, 26, 28, 30 via the transfer case 38 and other powertrain components. Various types of engines 34 may be employed in the vehicle 20 including, but not limited to, a combustion engine, an electric motor, and a hybrid-type of engine that may combine both the electric motor and combustion engine. The vehicle 20 may be an automobile, truck, van, sport utility vehicle, or any other self-propelled or towed conveyance suitable for transporting a burden

The BBW system 32 is configured to generally slow the speed and/or stop motion of the vehicle 20, and may include a plurality of brake assemblies (i.e., two front brake assemblies 42, 44 and two rear brake assemblies 46, 48), a brake pedal assembly 50, at least one hydraulic backup assembly (i.e., two illustrated as 52, 54), and a controller 56. Each brake assembly 42, 44, 46, 48 may be associated with respective wheels 24, 26, 28, 30 to separately facilitate deceleration of the associated wheel. Each hydraulic backup assembly 52, 54 may be associated with respective front brake assemblies 42, 44. As illustrated, the rear brake assemblies 46, 48 may not be associated with a hydraulic backup assembly. It is contemplated and understood that any number and/or combination of wheels, brake assemblies and backup assemblies may be employed in a vehicle with multiple wheels.

The power source 33 may be configured to separately provide electric power to the brake assemblies 42, 44, 46, 48 and the controller 56 via respective power conductors 58, 60, 62, 64, 66. This separation of power may facilitate a more robust and reliable power distribution network for the BBW system 32. That is, if electric power, for example, should fail at one brake assembly, the power may still be available at the remaining three brake assemblies. It is contemplated and understood that any configuration of a power distribution network is plausible and generally depends upon various attributes and designs of the BBW system 32 and/or the degree of enhanced robustness and BBW system reliability desired.

The controller 56 may include a processor (e.g., microprocessor) and a computer writeable and readable memory. The controller 56 is configured to receive various input signals indicative of sensory measurements taken by the brake assemblies 42, 44, 46, 48 and the brake pedal assembly 50. The sensory data is communicable to the controller 56 as needed for use with one or more braking algorithms stored in the memory of the controller 56. The sensory data may also be used to calculate, select, and/or otherwise determine a corresponding braking request or braking event in response to the detected and recorded measurements or sensory readings. Based on the determined braking request, or braking event, the controller 56 may perform various braking algorithms, speed calculations, distance-to-brake calculations, and other function. In addition, the controller 56 may control various braking mechanisms or systems such as, for example, an electronic emergency brake. The controller 56 may coordinate the brake torques applied for each wheel 24, 26, 28, 30, which may vary to maintain stability of the vehicle 20 (i.e., stability control type functions), manage wheel slips (i.e., anti-lock braking and traction control), and/or any other reason differential braking torque is needed. In the embodiment of an electric or hybrid powered vehicle, the controller 56 may also distribute the desired braking torque between the friction actuated brakes, via brake assemblies 42, 44, 46, 48, and regenerative braking via the electric drivetrain.

Non-limiting examples of the controller 56 may include an arithmetic logic unit that performs arithmetic and logical operations; an electronic control unit that extracts, decodes, and executes instructions from a memory; and, an array unit that utilizes multiple parallel computing elements. Other examples of the controller 56 may include an engine control module, and an application specific integrated circuit. It is further contemplated and understood that the controller 56 may include redundant controllers, and/or the system may include other redundancies, to improve reliability of the BBW system 22.

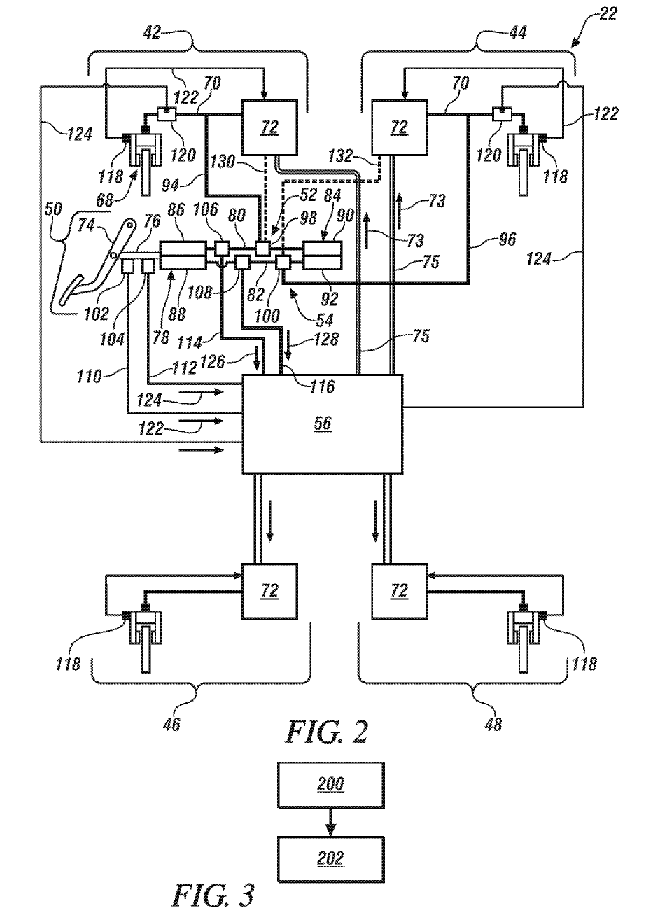

Referring to FIG. 2 and for simplicity of explanation, the front brake assembly 42 will be described with the understanding that the remaining brake assemblies 44, 46, 48 may be generally the same. Brake assembly 42 may include a brake 68, a hydraulic conduit 70, and an actuator 72 that may be adapted to hydraulically actuate the brake 68 via the hydraulic conduit 70. The brake 68 is illustrated as a caliper or disc brake; however, the brake 68 may be any type of brake including drum brakes, and others. The actuator 72 may be an electro-hydraulic brake actuator (EHBA), or other type of actuator capable of actuating the brake 68 based on an electrical input signal that may be received from the controller 56. More specifically, the actuator 72 may be, or includes, any type of motor capable of acting upon a received electric signal and, as a consequence, converts energy into motion that controls movement of the brake 68. Thus, the actuator 72 may be a direct current motor configured to generate electro-hydraulic pressure delivered to, for example, the calipers of the brake 68 via the hydraulic conduit 70. It is contemplated and understood that the term ‘hydraulic conduit’ may include a line, a tube, an opening, a channel defined within a housing or casement, and any other structure-defined-element capable of flowing fluid.

The actuators 72 of the brake assemblies 42, 44, 46, 48 may be ‘smart’ actuators each including a dedicated controller, a driver (i.e., one or more electronic power circuits), and an electric motor coupled to a hydraulic pump for driving the brakes 68. The actuator controller, driver, electric motor, hydraulic pump and brake 68 may be combined as a single component that facilitates fast, robust, and diagnosable communication within each brake assembly 42, 44, 46, 48, while reducing data latency.

The system controller 56 may be configured to selectively output a command signal (see arrow 73, e.g., low-power digital signal) over a pathway 75 and to the actuator controller in response to one or more braking events, such as an operator request to brake the vehicle 20. Examples of pathways 75 for delivering the command signal 73 may include, but are not limited to, FlexRay™, Ethernet, and a low-power message-based interface or transmission channel such as, for example, a controller area network (CAN or CAN-FD) bus. FlexRay™ is a high-speed, fault tolerant, time-triggered, protocol including both static and dynamic frames. FlexRay™ may support high data rates of up to ten (10) Mbit/s. In one embodiment, the system may be implemented with analog control voltages or currents.

The data command signal 73 initiates the actuator driver and motor to drive the pump and hydraulically actuate the calipers or brakes 68. In this manner, the enhanced smart actuators 72 may reduce the overall number of components and interconnection complexity of the BBW system 22 when compared to more conventional BBW systems. In addition, employment of one or more enhanced smart actuators 72 assist in eliminating long-distance, high-current, switching wires; thereby, reducing or even eliminating EMI emissions typically found in conventional BBW systems.

Each actuator controller of the smart actuator 72 may include programmable memory and a microprocessor. The programmable memory may store flashable software to provide flexibility for production implementation. In this manner, the actuator controllers may be capable of rapidly executing the necessary control logic for implementing and controlling the actuator drivers using a brake pedal transition logic method or algorithm that is programmed or stored in memory. In at least one embodiment, the actuator controllers may generate operational data associated with the vehicle 20. The operation data includes, but is not limited to, data indicating a torque force applied to a respective vehicle wheel, wheel speed of the wheel coupled to the respective brake, brake torque wheel speed, motor current, brake pressure, and brake assembly temperature.

The actuator controllers (e.g., the memory) may also be preloaded, or preprogrammed, with one or more braking torque look-up tables (LUTs) or braking torque data tables readily accessible by the microprocessor in implementing or executing a braking algorithm. In at least one embodiment, the braking torque LUT stores recorded measurements or readings of the brake pedal assembly 50 and contains an associated commanded braking request appropriate for each of the detected force measurements. In a similar manner, the actuator controllers may store a pedal position LUT that corresponds to the measurements or readings monitored by various sensors (to be discussed later) and contains a commanded braking request appropriate for the detected speed and/or position of the brake pedal assembly 50. The actuator controller(s) may also perform ESC functions, ABS function, and stability functions.

The brake pedal assembly 50 may include a brake pedal 74, a mechanical linkage 76 (e.g., push rod), a cylinder device 78, at least one hydraulic conduit (i.e., two illustrated as 80, 82), and an emulator device 84 adapted to simulate a brake pedal ‘feel’ similar to a more traditional, hydraulic, brake system. In one example, the cylinder device 78 may be a duplex cylinder device 78 including two cylinders 86, 88 with the first cylinder 86 being in hydraulic communication with the first hydraulic conduit 80, and the second cylinder 88 being in hydraulic communication with the second hydraulic conduit 82. The emulator device 84 may be a duplex emulator device including a first emulator 90 in hydraulic communication with the first conduit 80, and a second emulator 92 in hydraulic communication with the second conduit 82. The brake pedal assembly 50 is thereby configured to operate, in unison, two cylinders 86, 88 and two respective emulators 90, 92 via a single stroke of the brake pedal 74. This redundancy in actuation provides redundancy in hydraulics such that an undesired event (e.g., hydraulic leak) in one hydraulic backup assembly 52, 54 (also see FIG. 1) will not negatively impact the other hydraulic backup assembly.

The hydraulic backup assemblies 52, 54 may include respective hydraulic lines 94, 96 and respective valves 98, 100. The first hydraulic line 94 is in controlled fluid communication between the first hydraulic conduit 80 of the brake pedal assembly 50 and the hydraulic conduit 70 of the front brake assembly 42. The second hydraulic line 96 is in controlled fluid communication between the second hydraulic conduit 82 and the hydraulic conduit 70 of the other front brake assembly 44. The valves 98, 100 may each be diverter valves that may include a solenoid that maintains the valve 98, 100 in a normal position when energized and in a backup position when de-energized. The valves 98, 100 may be in fluid communication with (i.e., may be in, and/or generally interposed to) respective hydraulic conduits 80, 82 and respective hydraulic lines 94, 96. More specifically, Each diverter valve 98, 100 may generally have one inlet port in continuous fluid communication with the respective cylinders 86, 88 and two outlet ports. The first outlet ports of each valve 98, 100 are in fluid communication with the respective emulators 90, 92, and the second outlet ports are in fluid communication with the respective hydraulic lines 94, 96 and/or respective hydraulic conduits 70.

When the BBW system 20 is in a normal operating mode, the solenoid of the diverter valves 98, 100 are energized, the hydraulic lines 94, 96 are isolated from the respective hydraulic conduits 80, 82 of the brake pedal assembly 50, and the hydraulic conduits 80, 82 provide fluid communication between the respective cylinders 86, 88 and emulators 90, 92 through the respective valves 98, 100. When the BBW system 20 is in a backup mode (e.g., loss of electrical power), the solenoid of the diverter valves 98, 100 are de-energized, the emulators 90, 92 are isolated (i.e., not in fluid communication with the respective cylinders 86, 88, and the cylinders 86, 88 are in fluid communication with the brakes 68 of the respective brake assemblies 42, 44. That is, when in the backup mode, the operator may decelerate the vehicle by depressing the brake pedal 74, which in turn actuates the cylinders 86, 88, flows hydraulic fluid through the de-energized diverter valves 98, 100, through the hydraulic lines 94, 96, and generally into the brakes 68 of the respective brake assemblies 42, 44. It is contemplated and understood that the inherent design of the actuators 72 may prevent any backflow of hydraulic fluid into the actuators 72 during the backup mode, which may otherwise degrade braking performance. It is further contemplated that the BBW system 20 may operate in a partial backup mode where, for example, electrical power is lost to brake assembly 42, but not necessarily to brake assembly 44. In this scenario, brake assembly 42 may operate under the backup mode previously described, and brake assembly 44 may operate under the normal operating mode.

The BBW system 22 may further include a multitude of sensors and electrical pathways that may be hardwired or wireless. For example, the brake pedal assembly 50 may further include at least one travel sensor (i.e., two illustrated as 102, 104), and two pedal force or pressure sensors 106, 108. All four sensors 102, 104, 106, 108 may be configured to communicate with the controller 56 over respective pathways 110, 112, 114, 116. Each brake assembly 42, 44, 46, 48, may include a wheel speed sensor 118 and a hydraulic pressure sensor 120 (i.e., only illustrated on front brake assemblies 42, 44). The wheel speed sensor 118 may be configured to communicate with the smart actuator 72 over pathway 122, and the pressure sensor 120 may be configured to communicate with the controller 56 over pathway 124.

The two travel sensors 102, 104 provide a redundancy in the brake pedal assembly 50 that facilitates system robustness. The force sensors 106, 108 may be configured to measure hydraulic pressure in the respective hydraulic conduits 80, 82, and may be disposed between the respective cylinders 86, 88 and respective valves 80, 82. Like the travel sensors 102, 104, the two force sensors 106, 108 may contribute toward system redundancy that facilitates system robustness.

During normal BBW system 22 operation, brake pedal travel and/or braking force applied to the brake pedal 74 may be determined via the sensors 102, 104, 106, 108 and respective, outputted, braking intent signals (see arrows 122, 124, 126, 128) to the controller 56. According to one, non-limiting, embodiment, the force sensors 106, 108 may be implemented as a fluid pressure transducer or other suitable pressure sensor configured or adapted to precisely detect, measure, or otherwise determine an applied pressure or force imparted to the brake pedal 74 by an operator of the vehicle 20. The pedal travel sensors 102, 104 may be implemented as a pedal position and range sensor configured or adapted to precisely detect, measure, or otherwise determine the relative position and direction of travel of the brake pedal 74 along a fixed range of motion when the brake pedal 74 is depressed or actuated by the operator.

The measurements or readings obtained by the pedal force sensors 106, 108 and the pedal travel sensors 102, 104 are transmittable, or communicable, as needed for use with one or more braking algorithms that may be stored in the memory of the electronic controller 56. The data from the pedal force sensors 106, 108 and/or pedal travel sensor 102, 104 may also be used to calculate, select, or otherwise determine a corresponding braking request, or braking event, in response to the detected and recorded measurements or readings outputted as signals 122 from the wheel speed sensors 118. The signals 122, or data, are delivered from the smart actuator 72 and to the controller 56 via the bus 75, which may be bi-directional. Based on the determined braking request, or braking event, the controller 56 may perform various braking algorithms, speed calculations, distance-to-brake calculations, and others.

The pressure sensor 120 may be configured to measure hydraulic fluid pressure in the hydraulic conduit 70 of, for example, the brake assembly 44. This pressure may be indicative of the amount of force (e.g., clamping force) that the brakes 68 are applying to the respective wheels. In general, the controller 56 is the master over the smart actuator 72. The controller 56 may use the pressure signals to ‘close the loop’ and confirm that the smart actuator 72 is applying the amount of brake torque commanded. In a faulted system (i.e., fluid leak between actuator and brake caliper, or other fault), the pressure sensor 120 may provide a means for the controller 56 to detect the fault condition.

In one embodiment, the use of the hydraulic pressure sensors 120 may be limited to the front brake assemblies 42, 44. Motor current in the rear brake assemblies 46, 48 may be analogues to the hydraulic pressure. Moreover, the wheel speed sensors 118 may allow the controller 56 to determine the amount of ‘slip’ of each wheel 24, 26. The observance of an expected wheel slip is also an indicator that the brakes are being applied.

During normal operation of the brake pedal assembly 50, an operator of the vehicle 20 may depress or actuate the brake pedal 74 that causes the push rod 76 to generally push against the hydraulic fluid in both cylinders 86, 88 of the cylinder device 78. The subsequent increase in hydraulic fluid pressure causes the fluid to flow through the hydraulic conduits 80, 82 and into the respective emulators 90, 92 of the emulator device 84. The emulators 90, 92 may be passive emulators, meaning they are not controlled directly by the controller 56, and instead are designed to restrict the flow of hydraulic fluid through various internal opening(s) to simulate a brake pedal ‘feel’ of a more traditional hydraulic brake system. One example of a hydraulic emulator is taught in U.S. patent application Ser. No. 15/282,145, titled: A Brake Pedal Emulator of a Brake-by-Wire system, filed on Sep. 30, 2016, and incorporated herein by reference in its entirety.

Also during normal operation and as the operator depresses the brake pedal 74, the controller 56 may receive the signals 122, 124, 126, 128 of the respective travel and force sensors 102, 104, 106, 108 that are indicative of operator braking intent. In-turn, the controller 56 may process such signals, and based at least in-part on those signals, output the command signal 73 to the actuators 72 over the respective busses 75. Based on any variety of vehicle conditions, the command signal(s) 73 directed to each wheel 24, 26, 28, 30 may be the same or may be distinct signals for each wheel. Once the actuator controller of the smart actuators 72 receives the command signal 73, the actuators 72 will function as previously described. It is contemplated and understood that the braking operation need not be initiated by the brake pedal input. Instead, other features of the vehicle (e.g., full range adaptive cruise control, collision imminent braking, and/or advanced parking assist) may command braking and the controller 56 may take those requests and control the pressure at each wheel.

With regard to the diverter valves 98, 100 and during normal operation of the BBW system 22, the smart actuators 72 of the brake assemblies 42, 44 may send electrical power to the solenoids of the respective valves 98, 100 via respective electrical conductors or pathways 130, 132, thereby holding the valves in the normal position as previously described. In the event the BBW system 20 loses all electrical power, or in the event of any number of abnormal operating events that may cause the smart actuators 72 to discontinue sending power to the valves 98, 100, the de-energized valves will re-align to the backup position and divert hydraulic fluid flow as previously described.

Referring to FIG. 3, a method of operating the BBW system 22 is illustrated. In block 200, a diverter valve 98 may be energized and thus sustained in a normal position during a normal operating mode of the system 22. When in the normal position fluid communication is established through the valve 98 and between the hydraulic cylinder 86 and the hydraulic emulator 90 of the brake pedal assembly 50. At block 202, the diverter valve 98 may be de-energized as a result of, for example, a power loss. De-energization of the valve 98 may cause the valve to move or shift from the normal position and to a backup position. When in the backup position, fluid communication is established through the valve 98 and between the hydraulic cylinder 86 and the brake 68.

Advantages and benefits of the present disclosure include a hydraulic backup mode for a BBW system that does not require a vacuum booster and does not require electrical power to operate. Other advantages may include individually operating corner brake assemblies controlled via a serial bus, use of normally closed hydraulic diverter valves, and a small, un-boosted, master cylinder device.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A brake-by-wire (BBW) system of a vehicle comprising:
a controller;
a brake assembly including a brake and an actuator operatively connected to the brake when the BBW system is in at least a normal operating mode;
a brake pedal assembly operatively coupled to the brake when the BBW system is in a backup operating mode, and operatively coupled to the controller when in the normal operating mode, wherein the controller is configured to receive braking intent signals from the brake pedal assembly and output a command signal to the actuator, and wherein the actuator is constructed and arranged to drive the brake indicative of the command signal when the BBW system is in the normal operating mode; and
a hydraulic backup assembly including a hydraulic line in controlled fluid communication with and between the brake and the brake pedal assembly, and a valve coupled to the hydraulic line and constructed and arranged to be in a normal position hydraulically isolating the brake pedal assembly from the brake indicative of the normal operating mode, and in a backup position providing fluid communication between the brake pedal assembly and the brake indicative of the backup operating mode.

2. The BBW system set forth in claim 1, wherein the valve is constructed and arranged to be electrically energized when in the normal position and electrically de-energized when in the backup position.

3. The BBW system set forth in claim 1, wherein the actuator is a hydraulic actuator and the brake assembly includes a hydraulic conduit in fluid communication between the brake and the actuator.

4. The BBW system set forth in claim 1, wherein the brake pedal assembly includes a brake pedal, a hydraulic cylinder mechanically coupled to the brake pedal, and a hydraulic emulator in fluid communication with the hydraulic cylinder when in the normal operating mode.

5. The BBW system set forth in claim 4, wherein the valve is a diverter valve disposed between the hydraulic cylinder and the hydraulic emulator, and constructed and arranged to isolate fluid communication between the hydraulic emulator from hydraulic cylinder when in the backup position.

6. The BBW system set forth in claim 5, wherein the valve is constructed and arranged to isolate fluid communication between the brake and the brake pedal assembly when in the normal position.

7. The BBW system set forth in claim 6, wherein the valve is electrically energized when in the normal position and de-energized when in the backup position.

8. The BBW system set forth in claim 7, wherein the actuator is a hydraulic actuator and the brake assembly includes a hydraulic conduit in fluid communication between the brake and the actuator.

9. The BBW system set forth in claim 8, wherein the actuator is a smart actuator and is configured to receive a command signal from the controller that is at least indicative of the operator intent.

10. The BBW system set forth in claim 8, wherein the actuator is a smart actuator and is configured to energize the valve when in the normal operating mode.

11. The BBW system set forth in claim 9, wherein the actuator communicates with the controller via a serial bus.

12. The BBW system set forth in claim 1, wherein the brake assembly includes a brake and a hydraulic actuator in fluid communication with the brake to facilitate deceleration, and wherein the hydraulic line is in fluid communication with the brake and with the hydraulic actuator.

13. The BBW system set forth in claim 4, wherein the hydraulic cylinder is an un-boosted cylinder.

14. A method of operating a BBW system comprising:
operating a brake pedal assembly with a diverter valve in a normal position during a normal operating mode of the system, wherein fluid communication is provided between a hydraulic cylinder and a hydraulic emulator of the brake pedal assembly; and
de-energizing the diverter valve, wherein the diverter valve moves from the normal position to a backup position, thus providing fluid communication between the hydraulic cylinder and a brake.

15. The method set forth in claim 14, wherein the hydraulic emulator is not in fluid communication with the hydraulic cylinder when the diverter valve is in the backup position.

16. The method set forth in claim 15, wherein a controller electrically commands a hydraulic actuator constructed and arranged to actuate a brake when the system is in the normal operating mode.

17. The method set forth in claim 16, wherein the brake is directly hydraulically actuated by the hydraulic cylinder when the system is in the backup operating mode.

18. The method set forth in claim 17, wherein the actuator is a smart actuator and is configured to energize the diverter valve when the system is in the normal operating mode.
